(19) United States
(12) Patent Application Publication
(10) Pub. No.: US 2024/0201896 A1
(43) Pub. Date: Jun. 20, 2024

(54) FIELD DEVICE

(71) Applicant: Endress+Hauser SE+Co. KG, Maulburg (DE)

(72) Inventors: Harald Schäuble, Lörrach (DE); Bernd Strütt, Steinen (DE); Christoph Schleith, Schopfheim (DE)

(21) Appl. No.: 18/554,851

(22) PCT Filed: Mar. 21, 2022
(86) PCT No.: PCT/EP2022/057301

§ 371 Date: Oct. 11, 2023

(30) Foreign Application Priority Data
Apr. 14, 2021 (DE) 10 2021 109 400.3

(51) Int. Cl. G06F 3/06

(52) U.S. Cl. CPC G06F 3/0656; G06F 3/0616; G06F 3/0685

(57) ABSTRACT

A field device in which device-related data are intelligently stored such that the lifetime of the memory unit and thus the possible service life of the field device is increased initially buffer-stores the generated data in a FRAM-based buffer memory unit and then stores them as a common data packet in an EEPROM-based long-term memory unit as soon as the device-related data have reached a defined data volume in the buffer memory unit. Collecting the data beforehand and then copying the resulting data packet to the long-term memory unit in the form of a common dataset reduces the write cycles to the EEPROM memory, as a result of which the lifetime of the EEPROM memory is lengthened. It is not necessary to retain any large FRAM-based data memory, making it possible to keep memory space costs for the field device low.

The invention relates to a field device in which device-related data can be intelligently stored, thereby increasing the lifetime of the data memory and thus the possible service life of the field device.

In process automation technology, field devices are often used to record or influence certain process variables. For the recording of the respective process variable, the field device comprises, depending upon the type, a specific sensor unit in which a corresponding measuring principle is implemented. Depending upon the design, the respective field device type can thus be used, for example, to measure a fill-level, a flow rate, a pressure, a temperature, a pH value, and/or a conductivity. A wide variety of such field devices are manufactured and distributed by the Endress+Hauser corporate group.

In general, a large amount of device-related data must be saved or modified for field devices. These can, for example, be measured values, diagnostic data, or configuration data of the device display. However, data that must be constantly modified, such as meters for operating hours, must also be stored. However, for this purpose, only limited power is available to the respective field device type, mainly due to explosion protection specifications, such as “4-20 mA” or “Profibus®.” Therefore, an EEPROM-based data memory (“electrically erasable programmable read-only memory”), rather than a flash-based data memory, is typically used to store device-related data. In addition, at least one of these data memories is arranged in a disconnectable manner on or in the field device. In this way, sensitive, device-related data may be transferred or assigned to a replacement field device in the event of a defect in the field device so that, for example, recalibration can be avoided on the replacement device.

However, a disadvantage of EEPROM-based memories is that they can be reliably rewritten only for a limited number of 10⁴ to 10⁵ write cycles. In extreme cases, this means that the field device can no longer be used after just a few months, since no further data can be stored. To be sure, FRAM-based data memories (“non-volatile ferroelectric random access memory”) are also highly energy-efficient and reliable for 10⁶ to 10¹⁴ write cycles, i.e., they can be rewritten without errors. However, FRAM-based data memories are disproportionately more expensive per memory capacity than EEPROM-based memories.

One possible strategy to increase the usability of the field device with EEPROM-based field device memories despite the limited number of write cycles is to not store dynamic data at all, or to store it in a highly compressed form. In addition, the corresponding data processing unit of the field device can perform so-called “wear leveling” when writing to the data memory, according to which the write cycles are distributed evenly over the memory, so that individual memory cells are not written to too often, while other memory cells are written to only very rarely.

However, in particular with complex measurement applications of a field device that are associated with a high turnover of device-related data (e.g., with a high measurement rate and measurement values with a large volume of data, as is the case with imaging or radar-based measurement principles), such measures are not sufficient to ensure enduring operational readiness of the field device. Therefore, the invention is based upon the object of realizing a field device with extended operational readiness.

This object is achieved by a field device comprising at least the following components:
a centralized data processing unit designed to receive device-related data, with
   a buffer memory unit that can be reliably rewritten for at least 10⁶ write cycles, in which the device-related data can be at least buffer-stored up to a defined data volume, and
a long-term memory unit that can be reliably rewritten for a maximum of 5*10⁵ write cycles, in which the central data processing unit copies at least a portion of the device-related data as a common data packet from the buffer memory unit, provided that the device-related data have reached the defined data volume in the buffer memory unit, or provided that a defined time interval has been reached.

Thus, the device-related data may be deleted from the buffer memory unit after copying to the long-term memory unit, in order to be able to record new data. Therefore, the idea according to the invention is to accumulate or buffer-store device-related data in a buffer memory that is, for example, at least 10× smaller than the long-term memory unit, but can often be rewritten, up to a “worthwhile” amount of data, and then to store it as a common data packet in a large, but less expensive, long-term memory. Thus, the long-term memory unit needs to be written to less frequently, potentially increasing the lifetime of the entire field device. Thereby, the idea according to the invention can be applied not only to a FRAM-based memory as an internal buffer memory unit and an EEPROM-based memory as a long-term memory unit, but also to any other memory types that have corresponding maximum memory cycles. The idea according to the invention is implemented most efficiently if the data processing unit copies not only a part of the data, but the entire data volume of device-related data as a common data packet from the buffer unit if the defined data volume or time interval is reached.

In particular, so that a replacement device can be set up on the basis of the data stored in the long-term memory unit in the event of a defect in the field device, it is advantageous for the long-term memory unit to be connected to the central data processing unit via a disconnectable and reconnectable interface.

Corresponding to the field device according to the invention, the object underlying the invention is achieved by a method for storing device-related data in the field device according to one of the preceding embodiment variants. Accordingly, the method comprises the following method steps:
receiving device-related data,
buffer-storing the received data in the buffer memory unit, and
copying at least a portion of the device-related data as a common data packet from the buffer memory unit to the long-term memory unit as soon as the device-related data has reached the defined data volume in the buffer memory unit, or as soon as a defined time interval has been reached.

The invention is explained in more detail with reference to the following FIGURE. In the FIGURE:

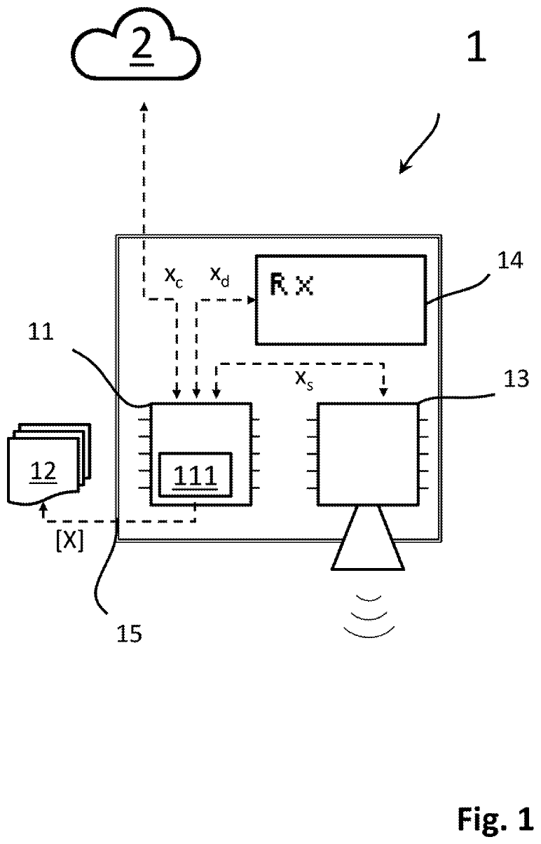

FIG. 1: shows a schematic structure of the field device according to the invention.

For an understanding of the invention, the structure of a field device 1 according to the invention is shown schematically in FIG. 1. Here, the field device 1 comprises an appropriately designed sensor unit 13, depending upon the field of application:
In the case of fill-level measurement, the sensor unit 13 can be designed to determine the fill-level based upon runtime by means of radar signals.
For pH measurement, the sensor unit 13 can be based upon an electrochemical sensor.
Pressure (difference) can be measured by means of a diaphragm or its deflection, e.g., by means of strain gauges.
With regard to pressure measurement, it is known from the prior art to implement the vortex or thermal measurement principle in the sensor unit 13.
Any temperature measurement can be resistance-based.

Regardless of the measuring principle or the application, the sensor unit 13 generates, on the one hand, measured values in the form of digital data xₛ. On the other hand, the sensor unit 13 is usually assigned calibration data xₛ or application-specific data xₛ, such as measuring ranges or limit values. In particular, such data xₛ of the sensor unit 13 must be retrieved recurrently, such that they must accordingly be stored in the field device 1. Corresponding data x_{d}, x_{c} of other units 14, such as configuration data x_{d} of a display 14 or setting data x_{c} of an interface to a higher-level unit 2 such as a process control system or a decentralized database, are also accordingly to be stored in the field device 1.

According to the invention, a central data processing unit 11 of the field device 1 stores such device-related data xₛ, x_{d}, x_{c} after their receipt in a FRAM-based buffer memory unit 111 assigned to it or in a comparable memory medium that is rewritable without errors for at least 10⁶ write cycles. Thereby, the data processing unit 11 stores incoming data xₛ, x_{d}, x_{c} in the buffer memory unit 111 until the buffer memory unit 111 is occupied up to a defined data volume [xₘₐₓ]. Thereby, the maximum data volume [xₘₐₓ] can be defined as the memory capacity of the buffer memory unit 111. Once such data volume [xₘₐₓ] has been reached in the buffer memory unit 111, the central data processing unit 11 copies as far as possible all the buffer-stored, device-related data xₛ, x_{d}, x_{c} as a common data packet [X] from the buffer memory unit 111 to an external long-term memory unit 12, which is based upon an EEPROM memory or a corresponding memory limited to a maximum of 5*10⁵ write cycles, but which results in lower memory costs compared to the FRAM-based buffer memory unit 111. If, for example, very little data xₛ, x_{d}, x_{c} is received temporarily due to an unmodified measurement situation, a time period of, for example, one hour, one day, or one month can also be defined in addition to the data volume [xₘₐₓ], after which the data xₛ, x_{d}, x_{c} is copied automatically, i.e., without having reached the data volume [xₘₐₓ], from the buffer memory unit 111 to the long-term memory unit 12.

By collecting the device-related data xₛ, x_{d}, x_{c} in the buffer memory unit 111 according to the invention and then copying them to the long-term memory unit 12 in the form of a common dataset [X], the write cycles to the EEPROM memory 12 are thus significantly reduced, which in turn can extend the operational readiness of the field device 1. At the same time, there is at least no need to retain a large FRAM-based data storage 111, making it possible to keep memory space costs for the field device 1 low. It is also advantageous that, with this method, very dynamic data xₛ, x_{d}, x_{c} may also be stored in the long-term storage unit 12.

This strategy according to the invention for storing device-related data xₛ, x_{d}, x_{c} results in a potentially longer service life of the field device, the greater the memory capacity of the long-term memory unit 12 is compared to the buffer memory unit 111. Therefore, it is advantageous if the long-term memory unit 12 ideally has a memory capacity that is at least twenty times greater than that of the buffer memory unit 111. In practice, it is therefore useful for the long-term memory unit 12 to have a size of at least 16 kilobytes, depending upon the application of the field device 1. To further minimize the write cycles to the long-term memory unit 12, in addition to the storage method according to the invention, the central data processing unit 11 can also copy the data packet [X] to the long-term memory unit 12 by “wear leveling” in manner that is as evenly distributed as possible.

With the embodiment of the field device 1 according to the invention shown in FIG. 1, it is shown schematically that the long-term memory unit 12 is arranged externally, i.e., not on a printed circuit board together with the central data processing unit 11, the sensor unit 13, and the display unit. Along with this, as indicated in FIG. 1, the long-term memory unit 12 is connected to the printed circuit board or the central data processing unit 11 via a disconnectable and reconnectable interface 15, such as “SPI (serial peripheral interface)” or “I²C.” Thus, in case of failure of the field device 1 or one of the other components 11, 13, 14, the long-term memory unit 12 can be connected to a replacement field device of the same type. Thus, the replacement device can access the stored, device-related data xₛ, x_{c}, x_{d}, which can significantly simplify the installation of the replacement device.

### LIST OF REFERENCE SIGNS

1 Field device
2 Higher-level unit
11 Central data processing unit
12 Long-term memory unit
13 Sensor unit
14 Display unit
15 Detachable interface
111 Buffer memory unit
[X] Data packet
x Device-related data
[xₘₐₓ] Maximum data volume

1-7. (canceled)

8. A field device, comprising:
a central data processing unit designed to receive device-related data, the central data processing unit having a buffer memory unit that can be rewritten for at least 10⁶ write cycles, in which the device-related data can be at least buffer-stored up to a defined data volume; and
a long-term memory unit that can be rewritten for a maximum of 5*10⁵ write cycles,
wherein the central data processing unit is configured to copy at least a portion of the device-related data as a common data packet from the buffer memory unit when the device-related data have reached the defined data volume in the buffer memory unit or when a defined time interval has been reached.

9. The field device according to claim 8, wherein the buffer memory unit is based upon a FRAM-based memory, and/or wherein the long-term memory unit is based upon an EEPROM-based memory.

10. The field device according to claim 8, wherein the data processing unit is configured to copy the entire data volume of device-related data as a common data packet from the buffer memory unit when the device-related data have reached the defined data volume in the buffer memory unit or when a defined time interval has been reached.

11. The field device according to claim 8, wherein the long-term memory unit is connected to the central data processing unit via a disconnectable and reconnectable interface.

12. The field device according to claim 8, wherein the long-term memory unit has a memory capacity of at least 16 kilobytes, in particular a memory capacity at least ten times greater than the buffer memory unit.

13. A method for storing device-related data in a field device, comprising:
providing the field device, including:
a central data processing unit designed to receive device-related data, the central data processing unit having a buffer memory unit that can be rewritten for at least 10⁶ write cycles, in which the device-related data can be at least buffer-stored up to a defined data volume; and
a long-term memory unit that can be rewritten for a maximum of 5*10⁵ write cycles,
wherein the central data processing unit is configured to copy at least a portion of the device-related data as a common data packet from the buffer memory unit when the device-related data have reached the defined data volume in the buffer memory unit or when a defined time interval has been reached;
receiving device-related data;
buffer-storing the received data in the buffer memory unit; and
copying at least a portion of the device-related data as a common data packet from the buffer memory unit to the long-term memory unit as soon as the device-related data has reached the defined data volume in the buffer memory unit or as soon as a defined time interval has been reached.

14. The method according to claim 13, further comprising:
deleting the device-related data from the buffer memory unit after copying it to the long-term memory unit.
